(19) United States
(12) Patent Application Publication
(10) Pub. No.: US 2017/0124908 A1
(43) Pub. Date: May 4, 2017

(54) SYSTEM AND METHOD FOR ENABLING A USER TO OVERCOME PESSIMISM

(71) Applicants: Jonnalagadda Sasidhar, Sleepy Hollow, NY (US); Sreenidhi Sundaran, Bangalore (IN); Gopi Ambikapathi Ambekar, Bangalore (IN)

(72) Inventors: Jonnalagadda Sasidhar, Sleepy Hollow, NY (US); Sreenidhi Sundaran, Bangalore (IN); Gopi Ambikapathi Ambekar, Bangalore (IN)

(73) Assignee: DHARMA LIFE SCIENCES LLC, Sleepy Hollow, NY (US)

(21) Appl. No.: 15/002,416

(22) Filed: Jan. 21, 2016

Related U.S. Application Data
(63) Continuation-in-part of application No. 14/931,868, filed on Nov. 4, 2015.

(51) Int. Cl. G09B 19/00; G06F 3/048; A63F 13/533; G09B 5/02; A63F 13/825

(52) U.S. Cl. CPC G09B 19/00; G09B 5/02; A63F 13/825; A63F 13/533; G06F 3/048

(57) ABSTRACT

A system is provided for enabling a user to overcome pessimism. The system is configured to enable the user to engage in a first and a second activity in a virtual environment, directed to rewire a first and a second defective wiring, respectively. The first defective wiring results in an individual giving priority to thoughts/facts that predict negative outcomes. The second defective wiring results in inability to weigh between positive and negative outcomes based on facts. Symptom of the first and the second defective wirings is pessimism. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome pessimism, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, pessimism may be caused by genetic predisposition and tendency to model the behavior of a family member who is also highly pessimistic, major tragedy or loss in an individual's past and haven't fully been able to grieve and accept the loss, experience of series of failures in life.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. Behavior of a pessimistic person may include believing that negative consequences are inevitable, attributing the negative consequences to themselves, believing positive events are caused by things outside their control, believing that positive events are temporary, over generalizing negative outcomes, having all-or-nothing thinking, which lead them to feel like a failure because of small misstep.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome pessimism, which can be classified as a weak personality trait based on the goals of the person.

### SUMMARY

An embodiment provides a system for enabling a user to overcome pessimism. The system includes an activity module. The activity module is configured to enable the user to engage in at least a first activity in a virtual environment. The first activity is directed to rewire a first defective wiring of the brain. The first defective wiring results in giving priority to thoughts/facts that predict negative outcomes. The activity module is further configured to enable the user to engage in at least a second activity in the virtual environment. The second activity is directed to rewire a second defective wiring of the brain. The second defective wiring results in inability to weigh between positive and negative outcomes based on facts. Symptom of the first and the second defective brain wirings is pessimism. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome pessimism. The method includes enabling the user to engage in at least a first activity in a virtual environment. The first activity is directed to rewire a first defective wiring of the brain. The first defective wiring results in giving priority to thoughts/facts that predict negative outcomes. The user is enabled to engage in at least a second activity in the virtual environment. The second activity is directed to rewire a second defective wiring of the brain. The second defective wiring results in inability to weigh between positive and negative outcomes based on facts. Symptom of the first and the second defective wirings is pessimism. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The yet another activity is directed to rewire the second defective wiring of the brain.

Yet another embodiment provides a system for enabling a user to overcome pessimism. The system includes an activity module configured to enable the user to engage in at least a first activity in a virtual environment, wherein the first activity is directed to rewire a first defective wiring of the brain, wherein the first defective wiring results in giving priority to thoughts/facts that predict negative outcomes. The activity module is further configured to enable the user to engage in at least a second activity in the virtual environment, wherein the second activity is directed to rewire a second defective wiring of the brain, wherein the second defective wiring results in inability to weigh between positive and negative outcomes based on facts, wherein symptom of the first and the second defective wirings is pessimism, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome pessimism;

FIG. 2 is a block diagram of an exemplary activity module 200 to overcome pessimism;

FIG. 2A is a block diagram of an exemplary behavioral traits database 202 of the activity module 200;

FIG. 2B is a block diagram of an exemplary collection of games 204 present in the activity module 200 to overcome pessimism;

FIG. 2C is a block diagram of an exemplary actions database 206 of the activity module 200 to overcome pessimism; and

FIG. 3 illustrates a flowchart of an exemplary method for overcoming pessimism.

### DETAILED DESCRIPTION

### I. OVERVIEW

### II. PRINCIPLE

### III. SYSTEM ARCHITECTURE

### IV. MODULES OF SYSTEM TO OVERCOME PESSIMISM

### V. METHOD FOR OVERCOMING PESSIMISM

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome pessimism, which is a weak behavioral trait. The solution is based on a principle that genetic and environmental factors (may be referred to as “cause”) cause defects in human brain wiring (may be referred to as “defect”), and such defects in human brain wiring express themselves in the form of pessimism (may be referred to as “symptoms”); hence, to overcome pessimism, the defective brain wirings have to be rewired, thereby providing a wholesome and long term solution to weak behavioral traits.

In an embodiment, a system is provided to overcome pessimism. The system may include an activity module. The activity module may be configured to enable the user to engage in activities in a virtual environment. The activities in the virtual environment facilitate rewiring of defective brain wirings, wherein the symptom of the defective brain wirings is pessimism. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

Pessimism can be defined as a persistive state in which an individual tend to perceive events as negative. Due to this quality in an individual, the individual tends to see the worst aspect of things or believe that the worst will happen.

Pessimism is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to pessimism, the brain of the pessimistic person is wired such that the person gives priority to thoughts/facts that predict negative outcomes, which is a defective brain wiring. Additionally, the brain of the person with pessimism is wired such that the individual is unable to weigh between positive and negative outcomes based on facts. Such defective brain wirings may have been caused by one or more of genetic predispositions. Further, pessimism may be a result of tendency to model the behavior of a family member who is also highly pessimistic, major tragedy or loss in their past and haven't fully grieved and accepted the loss, experience of a series of failures in life.

Embodiments provide a solution to rewire the defective brain wirings (addressing the defect) rather than just addressing the behavioral trait (symptom) without addressing the core defect. The solution is directed towards rewiring the defective brain wirings such that the ability to give priority or focus on thoughts/facts that predict a positive outcome is increased and ability to weigh between positive and negative outcomes based on facts is increased.

It is important to identify the brain wiring that results in development of a trait. A wholesome approach to overcome, eradicate or alleviate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Pessimistic individuals give priority to thoughts/facts that predict negative outcomes towards predicting negative outcomes and they unable to weigh between positive and negative outcomes based on facts. Different brain regions and neural network of the individual are responsible for such defects. Pessimists have weaker connection between prefrontal cortex (PFC) and amygdala. PFC which is involved in cognitive activity does not control the part of the brain which is associated with negative emotions. Hence, the enhanced activity of amygdala which is associated with less inhibition from prefrontal cortices and orbito frontal cortex results in pessimism.

### III. System Architecture

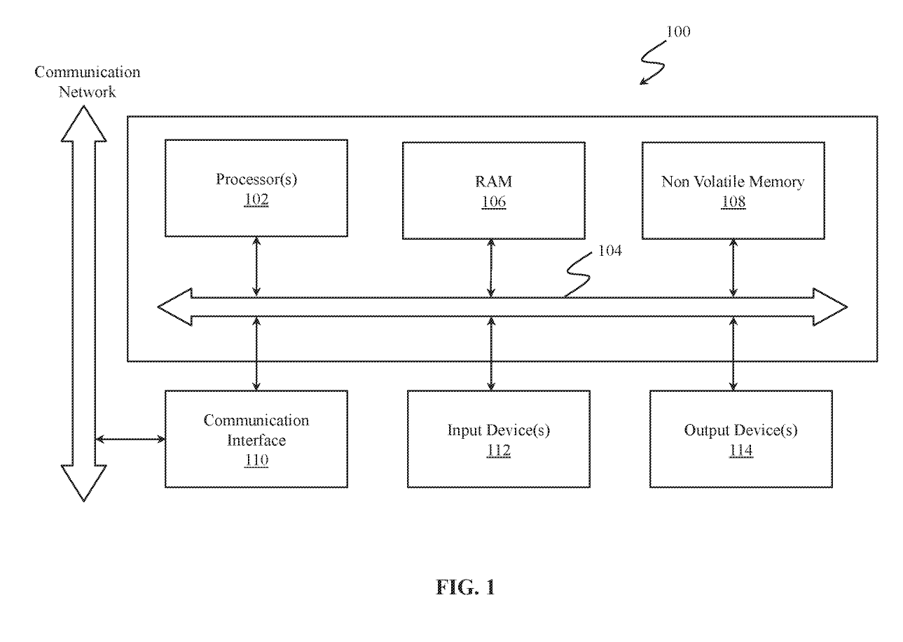

Referring to the figures, more particularly to FIG. 1, an exemplary architecture of an exemplary system 100 to overcome pessimism is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Pessimism

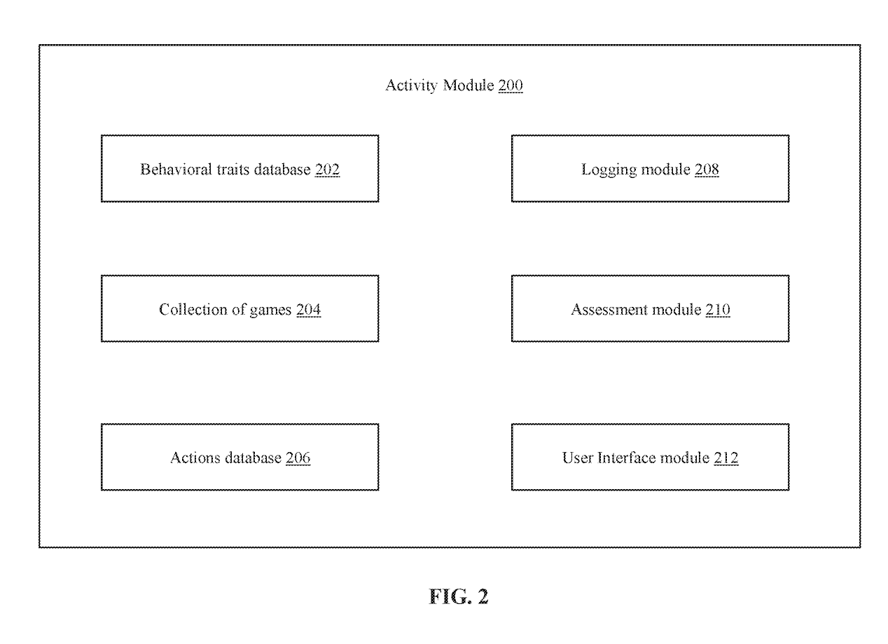

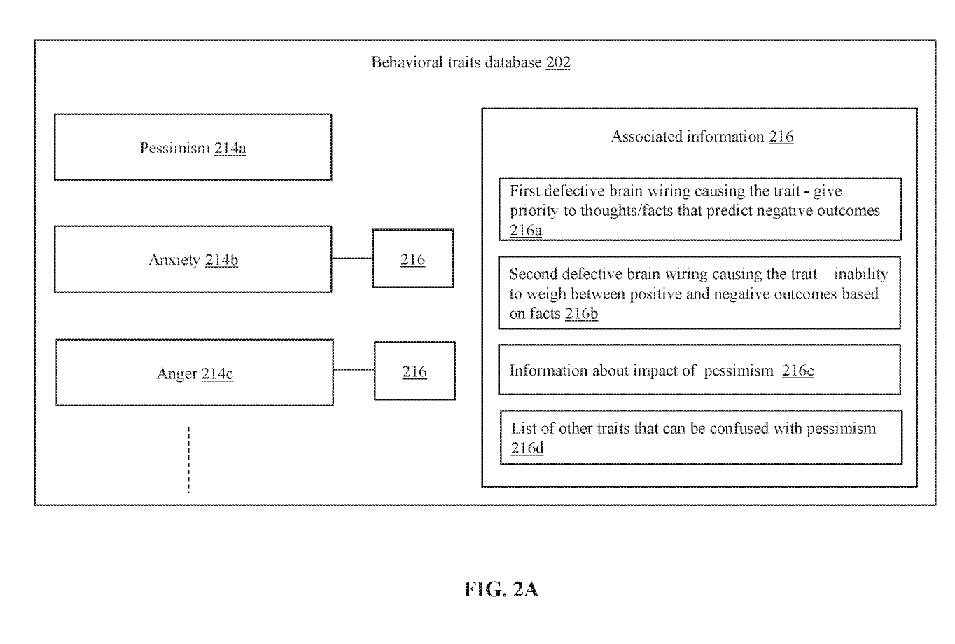

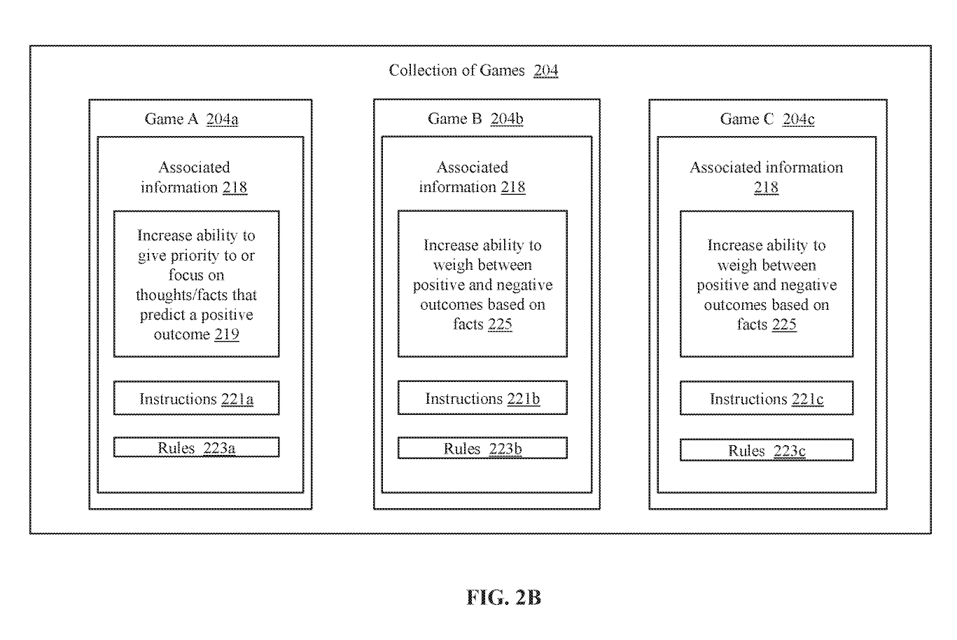

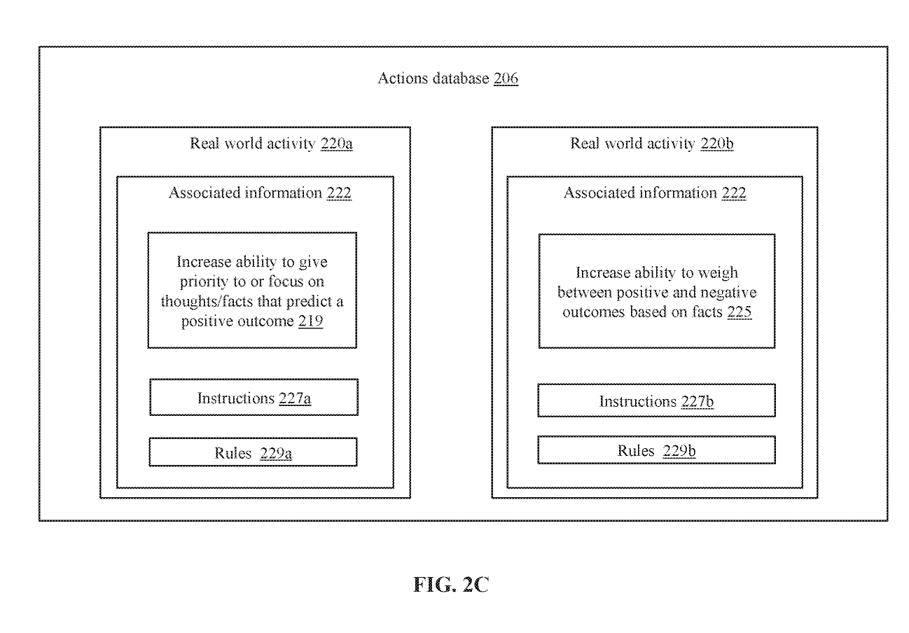

Referring to the figures, and more particularly to FIG. 2, the system 100 includes various modules for enabling users to overcome pessimism. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, pessimism 214a, anxiety 214b and anger 214c, among others. The traits database 202 may further include, with respect to one or more of the behavioral traits, information associated 216 with the trait 214.

With regards to pessimism 214a, the associated information 216 may include information corresponding to the defective brain wirings (defects) 216a and 216b causing pessimism (symptom of the defect), information about impact 216c of pessimism 214a on a person, and a list 216d comprising one or more traits that may be confused with pessimism 214a, among other information. Some or all of the associated information 216 may be displayed to the user of the activity module 200.

A first defective brain wiring 216a causing pessimism 214a is the brain wiring causing an individual to give priority to thoughts/facts that predict negative outcomes. A second defective brain wiring 216b causing pessimism 214a is the brain wiring causing inability to weigh between positive and negative outcomes based on facts.

In an embodiment, the information corresponding to the first and second defective brain wirings 216a, 216b causing pessimism 214a enable the activity module 200 to select games, activities or actions to overcome pessimism 214a.

In an embodiment, displaying the information corresponding to the defective brain wiring (defect) 216a, 216b causing pessimism 214a helps the user in understanding the defects responsible for pessimism 214a, thereby motivating the user to follow the instructions provided by the activity module 200.

Information about impact 216c of pessimism can include one or more of believing that negative consequences are inevitable, attributing the negative consequences to themselves, believing positive events are caused by things outside their control, believing that positive events are temporary, over generalization of negative outcomes and all-or-nothing thought, which leads to feel like a failure because of small misstep.

The list 216d of other traits that can be confused with pessimism 214a include depression, low self esteem and worry among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome pessimism 214a.

With regards to pessimism 214a, the brain rewiring attempted to achieve to overcome pessimism 214a includes rewiring the defective brain wirings 216a, 216b such that ability to give priority or focus on thoughts/facts that predict a positive outcome is increased and ability to weigh between positive and negative outcomes based on facts is increased.

In an embodiment, the activity module 200 may display the information corresponding to the causes (genetic or environmental) that resulted in the defective brain wirings (defect) 216a, 216b, which in turn resulted in pessimism 214a, thereby enabling the user to relate to the cause, defect and symptom of the defect, which results in a wholesome experience while working to overcome pessimism 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204d (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, three different games 204a-204c are included in the collection of games 204. The games 204a, 204b and 204c can be used by the activity module 200 to correct the defective brain wirings 216a and 216b by rewiring the brain to increase the ability to give priority to or focus on thoughts/facts that predict a positive outcome 219 and increase ability to weigh between positive and negative outcomes based on facts 225.

Game A 204a is directed at rewiring 219 the brain to increase the ability to give priority to or focus on thoughts/facts that predict a positive outcome. Game B 204b and Game C 204c is directed at rewiring 225 the brain to increase the ability to weigh between positive and negative outcomes based on facts.

Game A 204a may be designed to rewire the brain to give priority or focus on thoughts/facts that predict a positive outcomes 219. The game 204a may be a selection game. The game may require a user to choose a positive outcome from a number of different outcomes. The instruction 221a may include recommendation to play the game 204a for a predefined duration every day. The rules 223a may allow proceeding to a next level in the game 204a once a desired level of performance is achieved.

An example of Game A 204a is provided below where a random subset of the following will be shown to the user so that the user can select the statement that produces a positive outcome.

You have given the responsibility of organizing and hosting a small corporate event

### Predicted Positive Outcomes:

You will learn how to organize an event and it will add up to your experience
Your superiors in the office will appreciate your effort
You will make more corporate contacts because of this work
People from outside your office will notice your ability
It's going to add up to your appraisal which is just pending
Your family will be proud on you to see you hosting
While organizing you will learn how to manage huge money transaction
Your close friends will help you in scripting, writing and organizing the event
You might get some other events to host which you can endorse as an income source
Your colleagues will respect you and will trust you more than earlier

### Predicted Negative Outcomes:

You may not able to concentrate on your office work
This plan was quite last minute and you may not able to execute it properly
You are involved in organizing so won't get time to rehearse well
The party might be boring as it's about the company's anniversary
You will not able to give time to your family for some days
People might judge you based on your performance
If this event goes bad, then it may demotivate you, to organize events in the future
As the deadline is short you will have to work hard that may take a toll on your health
If the event goes poorly, then you may be held responsible for wasting the company's money.
Your office work will be pending

Game B 204b may be designed to increase the ability to weigh between positive and negative outcomes based on facts 225. The instruction 221b may include recommendation to play the game 204b for at least a predefined duration for a predefined number of days. The rules 223b may allow proceeding to a next level in the game 204b once a desired level of performance is achieved. The activity module 200 may set or configure or define complexities (e.g. complexities may be numbered on a scale of 1 to 10) for Game B 204b.

In an example of Game B 204b, the individual may be presented with a picture which includes fresh, partially rotten and fully rotten fruits. The individual is instructed to see the picture and then later ask to select the options which denote the quantity of rotten fruit presented in the picture.

### Complexity:

Fresh fruits v/s Partially rotten fruits(a)
Fresh fruits v/s Completely rotten fruits(b)
Fresh fruits v/s a+worms/b+worms/a&b+worms
   The ratio of rotten fruits and fresh fruits are maintained as per 80/20 rule, wherein 80% of the time the rotten fruits are less than 50% or equal to 50% in number and 20% of the time rotten fruits exceeds the fresh fruits number (i.e. Only two times out of ten the user will come across game where rotten fruits are more).

Game C 204c may be designed to enhance one's ability to weigh between positive and negative outcomes based on facts 225. The instruction 221c may include recommendation to play the game 204c for a predefined duration for a predefined number of days. The rules 223c may allow proceeding to a next level in the game 204c once a desired level of performance is achieved.

In Game C 204c, the individual may be provided with situations, which may be based on real life events. The individual may be recommended to choose an appropriate response to a series of questions based on evaluation and analysis of the situations. An example of Game C 204c is provided below.

### Situation:

You have a conference in your company which will provide a great exposure for your project that you have worked hard for. The conference will have many dignitaries. So the team chooses you to be the presenter for the conference as you have the knowledge in the project.
Q. So in this situation, what would you think?

### A:

I might get too nervous in the podium and spoil the whole presentation.
If people do not understand the project, it will all go for a toss.
I have all the knowledge about the project, so it will be a great opportunity to showcase my knowledge in this field.

### Situation:

The chief guest of the conference while giving the speech mentions that he is very interested in knowing about the project as he is not heard about such an idea before.
Q. So in this situation, what would you think?

### A:

Oh god! Now the pressure is too much to handle. Now I will for sure spoil the presentation.
If I do not present well, the chief guest will feel I am a fool.
The chief guest feels that the topic is new, which means the project has appealed to him.

### Situation:

When you get on the podium to start the presentation, the mike starts to screech. All the guests are disturbed by the screeching noise.
Q. So in this situation, what would you think?

### A:

This is for sure going to be a horrible conference.
If the beginning is bad, that means the whole presentation is an utter failure!
These small flaws happen all the time. It will not affect the presentation. Situation:
   When you start to present, you start off well and people seems to be listening to you. But through the presentation, you see that the chief guest is distracted.
   Q. So in this situation, what would you think?

### A:

I think I am making the presentation very boring.
He is not interested in my idea. This is such a horrible presentation of my life.
Maybe he is reflecting on the topic which is a good sign.
Expecting people to sit attentively in a conference is not realistic.
   Situation: When you end the presentation, the whole crowd starts to applaud and the chief guest is also applauding. At least ninety percent of the people come congratulating you.
   Q. So in this situation, what would you think?

### A:

All of them are just congratulating as a formality.
But some of your teammates did not come and congratulated you, which means the presentation was not great.
I am glad that the many of them actually came to me to convey their positive feedback.
The applaud of the crowd indicates that the presentation was great.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, each of the real world activities 220a-220b or sets of real world activities 220a-220b (may be referred by numeral 220) is used by the activity module 200 based on the brain rewiring 219, 225, which the real world activity 220 is capable of achieving.

Each real world activity 220 may include associated information 222. As an example, a real world activity may be capable of achieving more than one type of brain rewiring. Alternatively, one type of rewiring (219, 225) may be achieved by more than one real world activity/activities 220. Each real world activity 220 includes data indicating the brain rewiring(s) 219, 225 it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others. Each level alternative should have an editable option where users can edit what is written and do what they think is feasible for that day, such that whatever they write, should be saved as that alternative and will show up 5 times.

The real world activity 220a may be presented to the user after the user has at least participated in one or more games to a predefined extent that attempts to rewire 219 the first defective brain wiring 216a. The real world activity 220a may be designed to rewire the brain to increase the ability to give priority to or focus on thoughts/facts that predict a positive outcome. Instructions 227a may include recommendation that the action has to be carried out every day. Rules 229a may include recommendations that each level has to be repeated 5 times, as an example, before the next level unlocks.

In a first level, instructions 227a may be provided to the user to choose a quiet place to sit in and close the eyes and imagine in detail what is shown on a screen. The activity module 200 may choose the tasks to be shown on the screen sequentially and display it to the user.

### Screen 1:

If you catch yourself visualizing negatives of a situation, visualize possible success instead.
1. Think of an upcoming event which you have been very nervous about, imagine positive outcome of the event. Imagine only how the event will have positive results. Breathe deeply while you are imagining. Example: Think of attending an interview, and you successfully getting the job offer.
   Imagine your future with many positive aspects. Do not let your negative aspect interfere with your imagination. While imagining, believe it to be happening in real.
   Imagine that tomorrow is going to be a day going without any negative prediction.
   Imagine yourself as a person who have only positive outlook to any situations/events.
   Imagine a situation that you have been anticipating from a long time, now imagine the situation happening positively. Example: You are anticipating your date/marriage.

In a second level the activity module 200 may provide instructions 227a to the user to do the following actions The activity module 200 may choose the tasks to be shown on the screen sequentially and display it to the user.

### Screen 1:

Instead of saying, “I cannot”, say, “I can”. Whenever you hear yourself telling negative words, stop yourself and change it to positive words.
   If you hear yourself using negative words in your conversation, switch to positive words.
   Count your blessings and make a list of your blessing. A box may be provided to the user to provide his response.
   When things are going on a rough side, try to shift your focus to positives that are present in that situation.
   Volunteer in hospital, NGO or anything for the charity purpose. By end of the day, mention at least five positives that happened during the volunteering. A box may be provided to the user to provide his response.

In a third level, the activity module 200 may provide instructions 227a to the user to do the following actions. The activity module 200 may choose the tasks to be shown on the screen sequentially and display it to the user.

### Screen 1:

Instead of pointing out the obvious flaws of others, start accentuating and concentrating on the good.
Try to reassure your friends/colleagues positively in the times of distress.
Read a news paper and try to think of positives in the news.
Watch a movie with a sad ending and reflect on at least 5 positives of the situations that happened in the movie.
Try to compliment your friend/colleague about their positives

In a fourth level, the activity module 200 may provide instructions 227a to the user to think of a past historical disaster and come up with 5 positives of that situation, type them in a box provided on the screen to provide the response.

The real world activity 220b may be presented to the user after the user has at least participated in one or more games to a predefined extent that attempts to rewire 225 the second defective brain wiring 216b. The real world activity 220b may be designed to rewire the brain to increase the ability to weigh between positive and negative outcomes based on facts 225.

In a first level, instructions 227b may be provided to the user to choose a quiet place to sit in and close the eyes and imagine in detail what is shown on a screen. The activity module 200 may choose the tasks to be shown on the screen sequentially and display it to the user.

### Screen 1:

Imagine an upcoming event and estimate both positive and negative predictions, then analyzing the estimates, come up with a balanced/realistic prediction.
Think of an event for which you are feeling like giving up, imagine yourself setting a goal of doing the task for one more day. Also imagine yourself successfully completing the task.
Think of something that you always dreamed about happening to you, now imagine yourself in that situation and you happily experiencing it without any negative outcomes.
Imagine most catastrophic situation because of one negative event. Imagine till they become absurd. Play these scenarios over and over again; exaggerate those scenarios to the point of comic hilarity. Example: One missed deadline is the first step in a fast trip to permanent unemployment.
   A simple cough turns into pneumonia.
Imagine you are a person who is very pessimistic about yourself, your life. Think of an issue you have that tends to make you feel bad about yourself (a mistake you made, relationship issues, or your appearance). Try to imagine an imaginary friend who is also going through the similar situation, and imagine yourself giving support with compassion.

In a second level the activity module 200 may provide instructions 227b to the user to choose a quiet place to do the following actions. The activity module 200 may choose the tasks to be shown on the screen sequentially and display it to the user.

### Screen 1:

Think of three strengths of yourself; try to use each of them in the next three days. Instruction may be provided that this particular action should be carried out for 3 days, so the logging will be continued for 3 days.
Reflect on the day and write down at least 3 things that happened and why they happened. If the reason why the good things happened is because of a person, go to that person the next day and thank him/her. A box may be provided to the user to provide his response.
Deliver a letter of gratitude to someone who have been kind to you but never have thanked them properly. Write the letter of gratitude to at least 3 people

In a third level, the activity module 200 may provide instructions 227b to the user to do the following actions. The activity module 200 may choose the tasks to be shown on the screen sequentially and display it to the user.

### Screen 1:

When you see a dress displayed in a showroom, predict the quality, price and your first impression. Then check the texture of the clothes and price tag and analyze whether your prediction matches to the reality.
Try knowing a person towards whom you have had very poor opinion about. Try to assess their positives by conversing with them.
Go for a movie that has got bad reviews.
Try to act as an optimistic person. The “fake it to make it” approach has many successful results and don't give up at the first sign of trouble.
When you are receiving a gift from someone, try to analyze the reasons they are gifting.

In a fourth level, instructions 227b may be provided to the individual to mentor another individual who is a pessimist (and who wants to change) and guide them on the skills that you have learned. The person could be the individual's friend/family member or colleague.

In an embodiment, the action database 206 further includes plurality of physical actions, mind actions and dietary actions, one or more of which may be presented to a user who is trying to overcome pessimism 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Pessimism

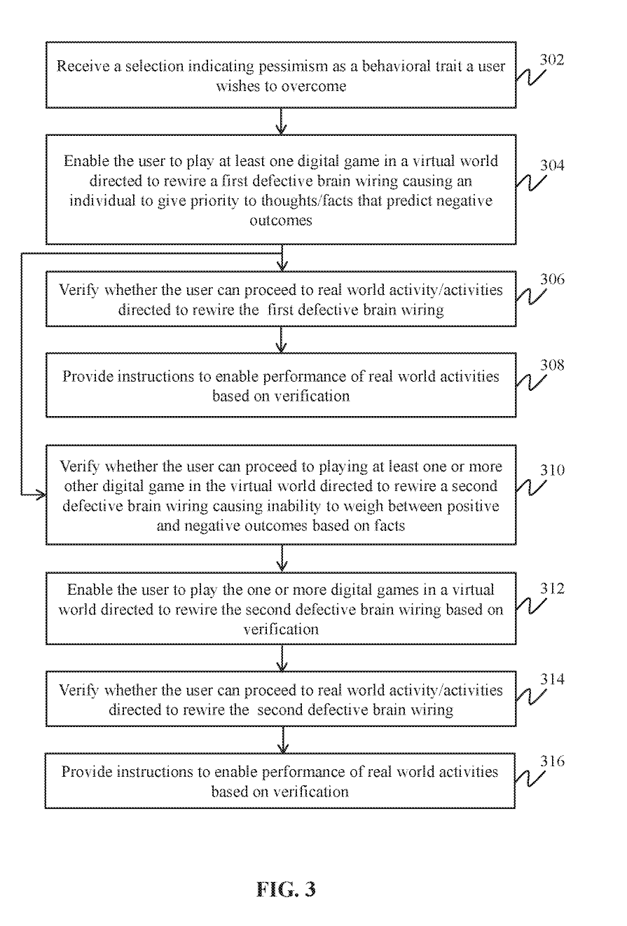

Now referring more particularly to FIG. 3, a method is provided for overcoming pessimism 214a. A selection indicating pessimism 214a as a behavioral trait which a user wishes to overcome is received at step 302. At step 304, a user is enabled to participate in/play at least one digital game 204a which is played in a virtual world. The digital game 204a is instrumental in rewiring 219 a first defective brain wiring 216a, whose symptom is exhibition of pessimism 214a. At step 306, verification is made to determine whether the user can proceed to perform real world activities 220a. In case it is determined that user can proceed, then at step 308, instructions are provided to the user to enable the user to perform appropriate real world activity/activities 220a. Preferably, the user is allowed to perform or instructed to begin performing appropriate real world activities 220a upon participating in the digital game 204a at least to a predefined extent, which is determined based on the desired rewiring. The real world activity 220a is instrumental in rewiring 219 the first defective brain wiring 216a, whose symptom is exhibition of pessimism 214a.

At step 310, verification is made to determine whether the user can proceed to playing one or more other digital games 204b and/or 204c in the virtual world directed to rewire a second defective brain wiring 216b causing inability to weigh between positive and negative outcomes based on facts. In case it is determined that user can proceed, then at step 312 the user is enabled to play/participate in the one or more digital games 204b and/or 204c, which are played in a virtual world. The digital games 204b-204c are instrumental in rewiring 225 the second defective brain wiring 216b, whose symptom is exhibition of pessimism 214a. Preferably, the user is allowed to proceed to playing at least one or more other digital games 204b and 204c upon participating in the game(s) instrumental in rewiring 219 the first defective wiring 216a at least to a predefined extent, which is determined based on the desired rewiring.

At step 314, verification is made to determine whether the user can proceed to perform real world activities 220b. In case it is determined that user can proceed, then at step 316, instructions are provided to the user to enable the user to perform appropriate real world activity/activities 220b. Preferably, the user is allowed to perform or instructed to begin performing appropriate real world activities 220b upon participating in one or all of the digital game(s) 204b and/or 204c at least to a predefined extent, which is determined based on the desired rewiring. The real world activity 220b is instrumental in rewiring 225 the second defective brain wiring 216b, whose symptom is exhibition of pessimism 214a.

In an embodiment, the user may be instructed to perform real world activity/activities 220b instrumental in rewiring 225 the second defective wiring 216b, after the user has participated in digital game 204b at least to an extent. In another embodiment, instruction may be provided to perform real world activity/activities 220b instrumental in rewiring 225 the second defective wiring 216b, after the user has participated in digital game 204c at least to an extent. In yet another embodiment, real world activity/activities 220b instrumental in rewiring 225 the second defective wiring 216b, may be instructed to be performed after the user has played each digital game 204b and 204c at least to an extent.

Referring to the step (302) of receiving a selection indicating pessimism 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of pessimism 214a, the activity module 200 may display a list 216d of other behavioral traits that can be confused with pessimism 214a, so that the user can select a more appropriate behavioral trait 214, which he desires to work on. The activity module 200 may further display the information corresponding to the brain wirings (defect) 216a, 216b causing the trait behavioral 214. The first defective brain wiring 216a causes giving priority to thoughts/facts that predict negative outcomes. The second defective brain wiring 216b causes inability to weigh between positive and negative outcomes based on facts.

The activity module 200 may additionally display information about impact 216c of pessimism 214a to the user. In addition, the activity module 200 may display information corresponding to the brain rewiring 219, 225 that the activity module 200 is attempting to achieve to overcome pessimism 214a. Rewiring 219 of the first defective brain wiring 216a results in increased ability to give priority to or focus on thoughts/facts that predict a positive outcome. Rewiring 225 of the second defective brain wiring 216b results in increased ability to weigh between positive and negative outcomes based on facts.

Furthermore, the activity module 200 may display the information corresponding to the causes (genetic or environmental) that resulted in the defective brain wirings (defect) 216a, 216b.

Referring to the step (304) of enabling the user to play at least one digital game in the virtual world directed to rewire the first defective brain wiring 216a, the activity module 200 may select one or more digital games based on the capability of the digital games to achieve the desired brain rewiring 219.

The activity module 200 may provide a choice (one or more games) of games, from which the user may select. The activity module 200 may even indicate the effectiveness of each of the games in achieving the desired brain rewiring 219 or an aspect of rewiring.

In an embodiment, the activity module 200 is configured to recommend a plurality of games 204, wherein the recommendation indicates each of the games' 204 effectiveness to achieve the desired brain rewiring 219 or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform real world activities 220a. Preferably, the activity module 200 recommends real world activities 220a after the user has performed to a desired extent in the digital game(s) 204. Desired extent of performance can be, as an example, levels completed, score reached and duration over which the game 204 was played.

In an embodiment, the activity module 200 recommends (step 308) participating in real world activity 220a or a part thereof, after the user has performed to a desired extent in the digital game 204a.

In an embodiment, the activity module 200 recommends participating in a level or part of real world activity (ex: level of real world activity 220a) after the user has performed to a desired extent in a level of the digital game (ex: level of digital game 204a), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing one or more other digital games in the virtual world directed to rewire the second defective brain wiring 216b causing an individual to fail in weighing between positive and negative outcomes based on facts. Rewiring the second defective brain wiring 216b results in ability to weigh between positive and negative outcomes based on facts.

In an embodiment, the activity module 200 recommends participating in digital games directed to rewire the second defective brain wiring 216b after the user has performed to a desired extent in the digital game(s) (204a) directed to rewire the first defective brain wiring 216a. In another embodiment, the activity module 200 recommends participating in digital games directed to rewire the second defective brain wiring 216b after the user has performed to a desired extent in the real world activity/activities (220a) directed to rewire the first defective brain wiring 216a.

The activity module 200, based on the verification, enables (step 312) the user to play/participate in one or more other digital games 204b and/or 204c in the virtual world directed to rewire the second defective brain wiring.

Referring to step 314, the activity module 200 verifies whether the user can proceed to real world activity/activities 220b directed to rewire 225 the second defective brain wiring 216b. In an embodiment, the activity module 200 recommends (steps 314, 316) participating in real world activity 220b or part thereof after the user has performed to a desired extent in the digital game 204b. Likewise, the activity module 200 recommends participating in real world activity 220b or part thereof after the user has performed to a desired extent in the digital game 204c. In another embodiment, the activity module 200 recommends participating in real world activity 220b or part thereof after the user has performed to a desired extent in each digital game 204b and 204c.

In another embodiment, the activity module 200 recommends participating in digital game 204b after the user has performed to a desired extent in a level of the digital game 204a. Similarly, the activity module 200 recommends participating in digital game 204c after the user has performed to a desired extent in a level of the digital game 204b.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting pessimism, the activity module 200 provides a scale operable by the user to select a position on the scale. The position may be indicative of the user's perception of how pessimistic he is. Improvement in overcoming or alleviating pessimism resulting from the rewiring of the brain achieved by the performance of the activities (virtual games or real world activities) enabled by the activity module 200 is reflected on the scale. Degradation in overcoming or alleviating pessimism resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome pessimism, the system comprising an activity module configured to:
enable the user to engage in at least a first activity in a virtual environment, wherein the first activity is directed to rewire a first defective wiring of the brain, wherein the first defective wiring results in giving priority to thoughts/facts that predict negative outcomes;
enable the user to engage in at least a second activity in the virtual environment, wherein the second activity is directed to rewire a second defective wiring of the brain, wherein the second defective wiring results in inability to weigh between positive and negative outcomes based on facts, wherein symptom of the first and the second defective wirings is pessimism;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to enable the user to engage in the second activity after the user has at least participated in the first activity.

6. A method for enabling a user to overcome pessimism, the method comprising:
enabling the user to engage in at least a first activity in a virtual environment, wherein the first activity is directed to rewire a first defective wiring of the brain, wherein the first defective wiring results in an individual giving priority to thoughts/facts that predict negative outcomes;
enabling the user to engage in at least a second activity in the virtual environment, wherein the second activity is directed to rewire a second defective wiring of the brain, wherein the second defective wiring results in an individual failing to weigh between positive and negative outcomes based on facts, wherein symptom of the first and the second defective wirings is pessimism;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity after the user has at least participated in the first activity.

11. A system for enabling a user to overcome pessimism, the system comprising an activity module configured to:
enable the user to engage in at least a first activity in a virtual environment, wherein the first activity is directed to rewire a first defective wiring of the brain, wherein the first defective wiring results giving priority to thoughts/facts that predict negative outcomes; and
enable the user to engage in at least a second activity in the virtual environment, wherein the second activity is directed to rewire a second defective wiring of the brain, wherein the second defective wiring results in an individual failing to weigh between positive and negative outcomes based on facts, wherein symptom of the first and the second defective wirings is pessimism, wherein engagement in the second activity is enabled after the user has at least participated in the first activity.

12. The system of claim 11, wherein,
the first activity is directed to rewire the first defective wiring so as to give priority or focus on thoughts/facts that predict a positive outcome; and
the second activity is directed to rewire the second defective wiring to increase the ability to weigh between positive and negative outcomes based on facts.
